(19) United States
(12) Patent Application Publication
(10) Pub. No.: US 2007/0073423 A1
(43) Pub. Date: Mar. 29, 2007

(54) Remote monitoring device for laundry machine

(76) Inventor: Ji An Jeong, Suwon-si (KR)

Correspondence Address: FLESHNER & KIM, LLP, P.O. BOX 221200, CHANTILLY, VA, 20153, US

(21) Appl. No.: 11/509,064

(22) Filed: Aug. 24, 2006

(30) Foreign Application Priority Data
Aug. 26, 2005 (KR) 10-2005-0079042
Aug. 26, 2005 (KR) 10-2005-0079043

(51) Int. Cl. D06F 33/00; G05B 19/18

(52) U.S. Cl. 700/65; 68/12.01; 700/66

(57) ABSTRACT

A remote monitoring device for a laundry machine is disclosed. The remote monitoring device for a laundry machine includes a case for defining an exterior thereof, a communication modem board provided within the case for transmitting/receiving data with a laundry machine performing washing and drying to control the laundry machine, a display window for displaying a condition of the laundry machine operation, a first mounting part provided on a rear surface of the case, and a stand installed in a remote place from the laundry machine for fastening the first mounting part thereto. An object of the present invention is to provide a remote monitoring device for a laundry machine which enables a user to recognize and control an operation condition of a laundry device at a remote place.

This application claims the benefit of the Patent Korean Application Nos. 10-2005-0079042 and No. 10-2005-0079043, filed on Aug. 26, 2005, which are hereby incorporated by reference as if fully set forth herein.

### BACKGROUND OF THE INVENTION

1. Field of the Invention

The present invention relates to a remote monitoring device, more particularly, to a remote monitoring device for a laundry machine which enables a user to recognize and control an operation condition of a laundry device at a remote place.

2. Discussion of the Related Art

In general, an electric appliance is operated in a house by electricity and is a device which converts electricity into light, heat and power to facilitate living in a house more conveniently.

Recently, as living space in a house is getting large, a laundry machine which performs washing and drying takes up much space, and then is installed in a back porch far from a living room because the laundry machine makes a lot and loud noise during the operation, compared with other electric appliances.

Thus, especially in the United States and Europe, the laundry machine is usually installed in a basement or storage far from the place where the actual living is made.

Since the laundry machine is commonly installed in a remote place far from a living room where a user spends much time with his/her family, the user may not recognize a present cycle, remaining time and a operating condition easily.

That is, there may be an inconvenience that the user should go and check the operation condition of the laundry machine quite often.

If the user forgets that he/she starts the laundry machine, the laundry might be abandoned within the laundry machine for a long time. Then, the laundry gets severe wrinkles or bacteria to damage fabric itself

Also, if the user may not recognize errors of cycles and may not take an appropriate step, the laundry is in contact with wash water and detergent for a long time only to cause a problem of decoloration or fabric damage.

### SUMMARY OF THE INVENTION

Accordingly, the present invention is directed to a remote monitoring device for a laundry machine.

An object of the present invention is to provide a remote monitoring device for a laundry machine which enables a user to recognize and control an operation condition of a laundry device at a remote place.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a remote monitoring device for a laundry machine includes a case for defining an exterior thereof; a communication modem board provided within the case for transmitting/receiving data with a laundry machine performing washing and drying to control the laundry machine; a display window for displaying a condition of the laundry machine operation; a first mounting part provided on a rear surface of the case; and a stand installed in a remote place from the laundry machine for fastening the first mounting part thereto.

A second mounting part may be further provided in a rear surface of the case to be fastened to a fixing member provided on the wall.

Here, a guide rib may be formed in the first mounting part and a guide recess corresponding to the guide rib may be formed in the stand to sliding-move the remote monitoring device so that the remote monitoring device is mounted in the stand.

Alternatively, a guide rib may be formed in the guide rib and a guide recess corresponding to the guide rib may be formed in the first mounting part to sliding-move the remote monitoring device so that the remote monitoring device is mounted in the stand.

The second mounting part may be spaced apart a predetermined distance from an upper portion of the first mounting part.

Also, the second mounting part is projected from a rear surface of the case and has a fastening groove to insertedly fix the fixing member therein.

An opened part connected with the fastening groove may be provided in the second mounting part in a direction of the fastening groove so that the fixing member is inserted therein.

A concave part, which is some part of the fastening groove concaved upwardly, may be provided in the fastening groove to seat the fixing member thereon.

Also, the second mounting part includes a fixing ring engaged to the fixing member, and a support part rotatably supporting the fixing ring to the rear surface of the case.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view schematically illustrating an operating condition of a remote controlling device according to the present invention;

FIG. 2 is a perspective view illustrating a remote monitoring device according to a first embodiment of the present invention;

FIG. 3 is a perspective view illustrating a rear surface of the remote monitoring device of FIG. 2.

FIG. 4 is a perspective view illustrating a stand mounting the remote monitoring device of the present invention thereto;

FIG. 5 is a perspective view illustrating a rear surface of a remote monitoring device according to a second embodiment of the present invention;

FIG. 6 is a perspective view illustrating a vibration sensing device of a drum type washing machine according to a type of the second embodiment of the present invention;

FIG. 7 is a perspective view illustrating a vibration device of a drum type washing machine according to another type of the second embodiment of the present invention; and

FIG. 8 is a perspective view illustrating a vibration sensing device of a drum type washing according to a third embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A remote monitoring device for a laundry machine according to the present invention includes a case, a communication modem board (not shown), a display window, a first mounting part and a stand. The case defines an exterior of the remote monitoring device 1 and the communication modem board (now shown) is provided within the case to transmit/receive data with a communication modem provided in a laundry machine installed in a remote place. The display window displays an operating condition of the laundry device. Also, the first mounting part is provided on a rear surface of the case and the stand is installed in a place remote from the laundry machine to fasten the first mounting part 13 thereto.

Referring to drawings, preferred embodiments of the present invention will be described to embody the object of the present invention in detail.

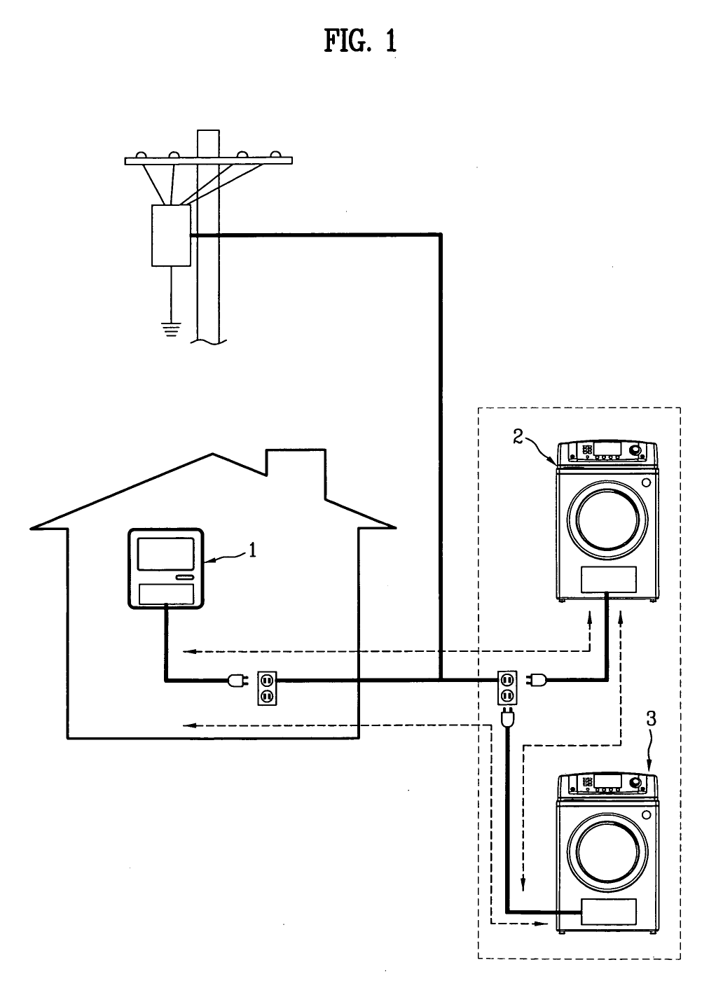

As shown in FIG. 1, a laundry machine 2 and 3 which performs washing or drying is generally installed in a place (for example, a back porch and a basement) remote from a living room or bedroom. A remote monitoring device 1 is installed in a place (for example, a living room or a bed room) where a user spends much time with his/her family.

The remote monitoring device 1 and the laundry machine 2 and 3 are electrically connected each other in a communication method.

That is, an electric wire communication modem is provided in each laundry machine 2 and 3 and a communication modem board (not shown) is provided in the remote monitoring device 1 to transmit/receive data through an electric wire with an electric wire of the communication modem provided in the laundry machine 2 and 3.

Once the laundry machine 2 and 3 is connected to an electric wire through a concent and the remote monitoring device 1 is connected to an electric wire, the remote monitoring device 1 is displaying an operating condition of the laundry machine 2 and 3, and a user may control the operation of the laundry machine 2 and 3 in a remote place.

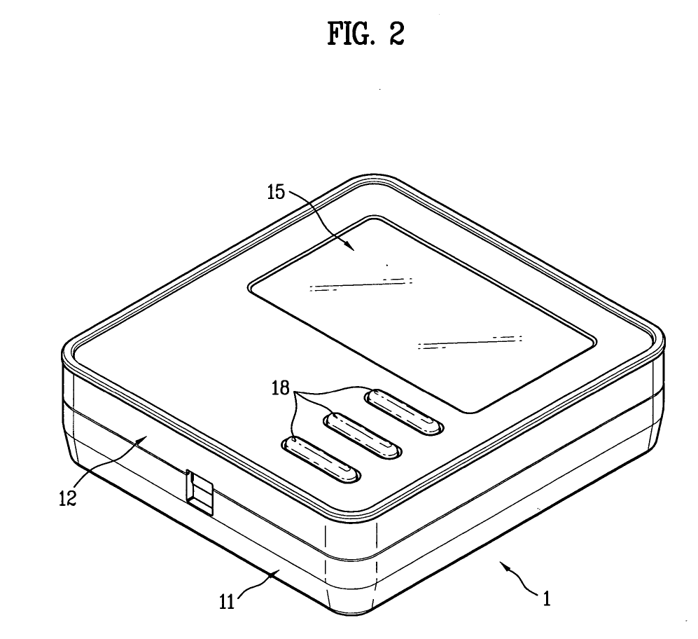

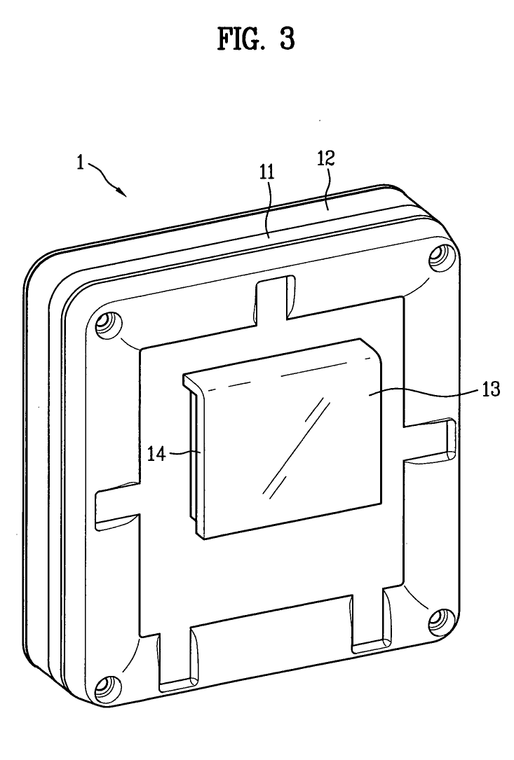

Referring to FIGS. 2 and 3, a first embodiment of the remote monitoring device according to the present invention will be described.

The exterior of the remote monitoring device 1 is defined by a lower case 11 and an upper case 12. The communication modem board (not shown), the display window 15 and parts including various buttons for controlling the remote monitoring device 1 and the laundry machine 2 and 3 are provided within space made by the lower case 11 and the upper case 12.

As shown in FIG. 3, a first mounting part 13 is projected from a rear surface of the lower case 11 to fasten the remote monitoring device 1 on a stand provided on a wall.

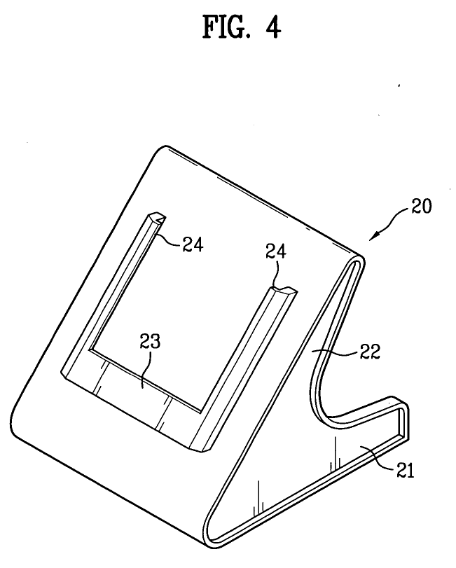

As shown in FIG. 4, the remote monitoring device 1 having the above configuration may be installed in any place the user wants by an auxiliary stand 20.

More specifically, the remote monitoring device 1 may be installed on a plate such as a table or desk in a living room or a bed room where the user spends a lot of time.

Here, the stand 20 includes a fixing part 21 fixed on a surface mounting the remote monitoring device thereon, and a seating part 22 having a guide part 23 to fasten/unfasten the remote monitoring device 1 there to/from.

Also, as shown in FIG. 3, a guide rib 14 is formed in both opposite sides of the first mounting part 13 and a guide recess 24 is upwardly projected in the seating part 22 in a predetermined height so that the guide rib 14 of the first mounting part 13 is slindingly inserted in the guide recess 24 to be fastened.

The seating part 22 of the stand 20 is inclined and installed on a place such as a table where the user may make an access thereto easily. Thereby, it is easy to fasten/unfasten the remote monitoring device 1 to/from the seating part 22 by the user's hands and it improves external beauty to fasten the remote monitoring device 1 on the seating part 24 in a perfectly fastened state.

The stand 20 shown in FIG. 4 has a hole (not shown) formed thereon for passing a screw through the fixing part 21, such that the stand 20 is fixed on a predetermined position and put on a place which the user wants without fixing it additionally.

In that case, an installing spot made to fix the stand 20 on a wall may not remain, thereby enhancing external beauty. Also, the user may move the installation position of the stand 20 easily. Also, the remote monitoring device 1, once installed, is slidingly separable from the stand 20 anytime.

By the way, as not described in detail, the fixing part 21 and the seating part 22 may be formed in the same direction and a hole (not shown) may provided to pass a screw for fixing the stand 20 to a wall there through.

The volume of the stand 20 is small and fixes the remote monitoring device 1 to the wall. Thereby, the stand 20 of the present invention has an advantageous effect that the user may see and find the remote monitoring device 1 easily.

Also, it is preferred that the size of the stand 20 and the seating part 22 is smaller than that of the lower case 11 so that the stand 20 may not be seen when the user sees the remote monitoring device 1 in front.

Thus, the stand 20 is fixedly installed on a wall by a fastening member such as a screw and the guide rib 14 formed in the first mounting part 13 is slindingly fastened to the guide recess 24 formed in the seating part 22 of the stand 20. Thus, the remote monitoring device 1 is easily mountable and separable.

Meanwhile, as described above, according to the remote monitoring device 1 of the first embodiment, the guide rib 14 is formed in the first mounting part 13 and the guide recess 14 is formed in the guide part 23 of the stand 20. Although not described and easily anticipated by anyone skilled in the art, a guide recess (not shown) may be alternatively formed in the first mounting part 13 and a guide rib (not shown) may be formed in the guide part 23 of the stand 20.

Next, an installing process of the remote monitoring device 1 and the stand 20 will be described.

First, to install the remote monitoring device 1, the stand 20 is fixed in a place the user wants.

Once the guide rib 14 formed in the first mounting part 13 of the remote monitoring device 1 is slidingly fastened to the guide recess 24 formed in the guide part 23 of the stand 20, the remote monitoring device 1 is fixedly installed to any place the user wants by the stand 20.

At that time, since the size of the stand 20 is smaller than the entire external size of the remote monitoring device 1, the stand 20 is not seen to enhance external beauty when the user seeing the remote monitoring device 1 in front.

Meanwhile, according to the remote monitoring device 1 of the first embodiment of the present invention, since only the first mounting part 13 is formed as a fixing means, the remote monitoring device 1 may be fixed only through the stand 20. Thus, the method for fixing the remote monitoring device 1 and the place where the remote monitoring device is installed are limited.

Next, a second embodiment of the present invention will be described, where a fixing member (not shown) such as a nail or a screw is provided on a wall to which the user wants to fix the remote monitoring device even without a stand 20 and a second mounting part 120 is further provided to fix the remote monitoring device 100 by engaging it to the fixing member.

Also, the same names and reference numbers are used to refer the same or like parts of the first embodiments, and the detailed description thereof will be omitted.

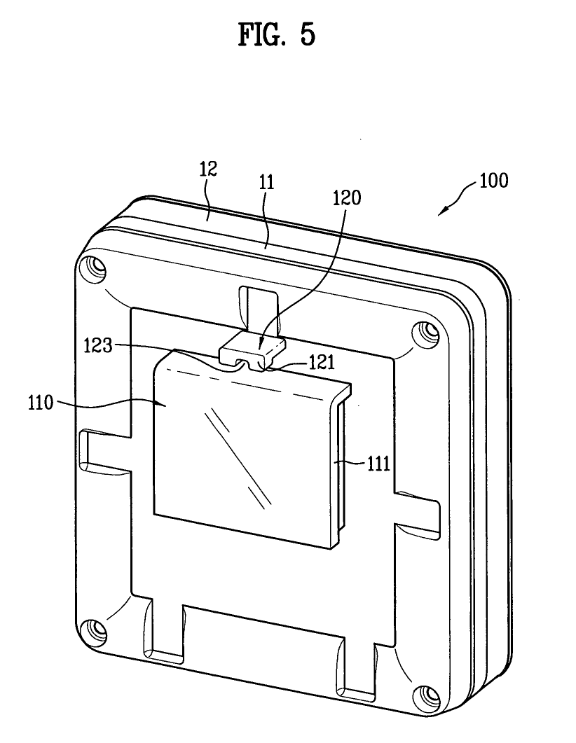

Referring to FIG. 5, the second embodiment of the remote monitoring device according to the present invention will be described.

Unlike the first embodiment described before, according to the second embodiment a first mounting part 110 and a second mounting part 120 are further formed. The first mounting part 110 fixes a remote monitoring device 100 to a stand 20 (see FIG. 4) and the second mounting part 120 fixes the remote monitoring device 100 to a fixing member (not shown) such as a nail or a screw.

The second mounting part 120 is projectedly formed in an upper portion of the first mounting part 110 and includes a fastening groove 123 horizontally formed with some part opened to insert the fixing member (not shown) therein.

Once the fixing member (not shown) is inserted and seated in the fastening groove 123, the fixing member (now shown) is prevented from being detached from the fastening groove 123. Thereby, the remote monitoring device 100 may be securely fixed.

Preferably, the second mounting part 120 is formed so that a position of the fixing member (not shown), where the fixing member is inserted and stopped, may be on a line passing a center of the remote monitoring device 100.

Also, preferably, a support part 121 formed in the fastening groove 123 of the second mounting part 120 spaced apart a predetermined distance from a rear surface of the lower case to facilitate the remote monitoring device 100 separable.

Next, an installment process of the remote monitoring device 100 according to the second embodiment of the present invention will be described.

To install the remote monitoring device 100, a user install the fixing member (now shown) such as a nail and a screw on a wall the user wants or an existing fixing member may be used.

Hence, once the fixing member such as a nail or a screw installed on the wall is fastened to the fastening groove 123 formed in the second mounting part 120 of the remote monitoring device 100.

The installation process of the case that the remote monitoring device 100 is installed by using the stand 20 is described in the first embodiment and the detailed description thereof will be omitted.

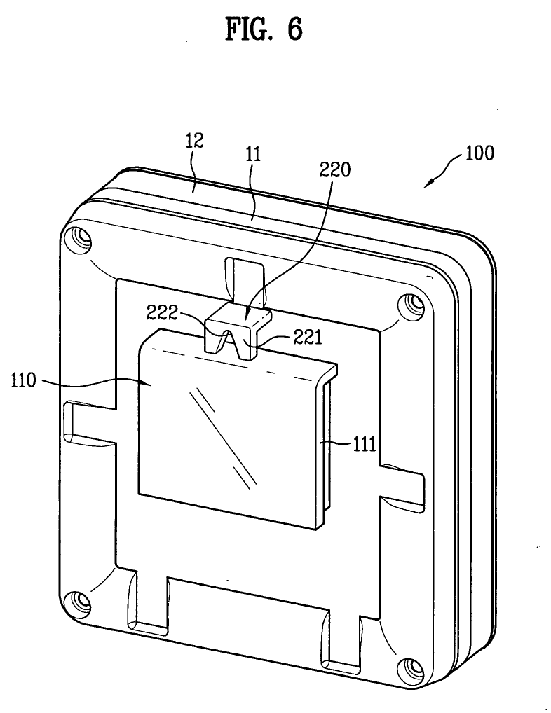

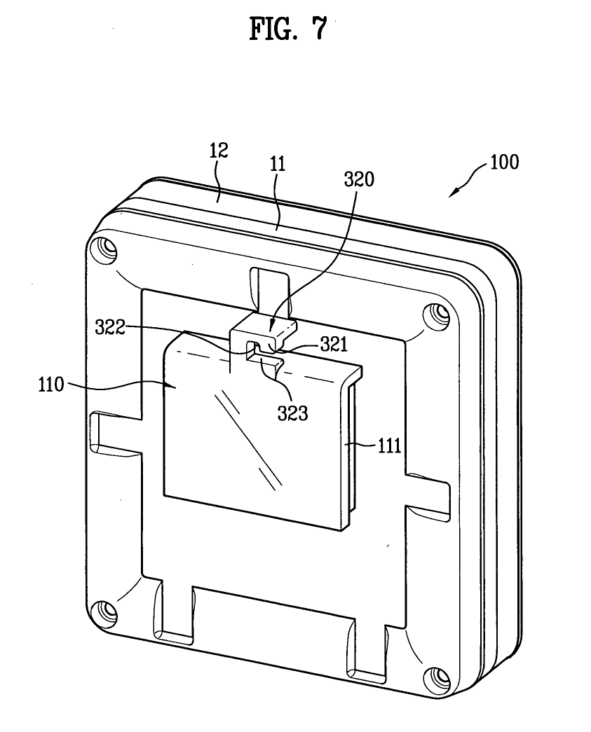

FIGS. 6 and 7 illustrate other types of the second embodiment.

As shown in FIG. 6, the fastening groove 222 may be formed in a ‘V’ shape where a lower portion thereof is wider than an upper portion thereof to fasten the remote monitoring device 100 to the fixing member 220 more securely. As shown in FIG. 7, a second mounting part 320 where an opened part 323 is formed in a side of a fastening groove 322 may be provided.

Especially in FIG. 7, the fixing member is slindingly moved along the opened part 323 to be inserted in the fastening groove 322. In that case, the remote monitoring device 100 may be installed to the fixing member more securely.

Although not described in detail, it is preferred that the fastening groove 123, 222 and 322 of the second embodiment includes a concave part concaved upwardly to seat the fixing member thereon.

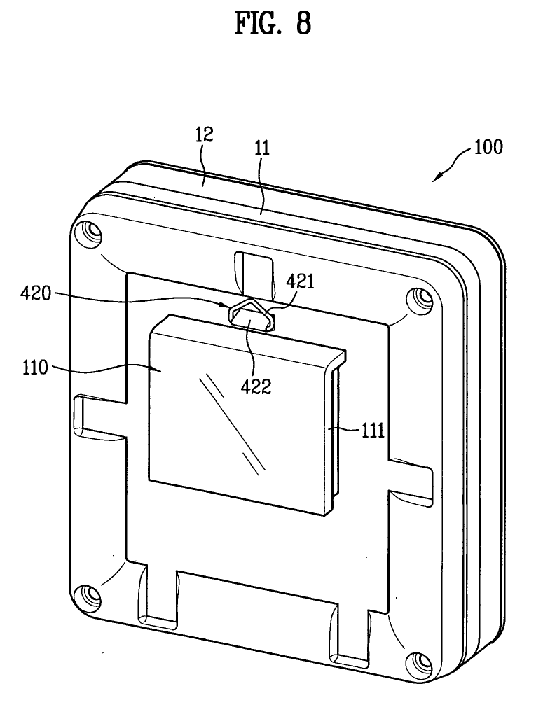

Next, referring to FIG. 8, a third embodiment of a remote monitoring device according to the present invention will be described.

In the third embodiment, a second mounting part 420 of the remote monitoring device 100 includes a fixing ring 421 and a support part 422, not the fastening groove inserting the fixing member (not shown) therein as described before. The fixing ring 421 is fixedly engaged to the fixing member and the support part 422 supports the fixing ring 421.

Especially, it is preferred that the fixing ring 421 is always in parallel with respect to a surface of the lower case 11 to make the fixing ring 421 separable.

For that, preferably a spring (not shown) is provide in the support part 422 to apply force in a direction making the fixing ring 421 in contact with the rear surface of the lower case 11.

Since the fixing ring 421 is closely contacted with the lower case 11, interference generated when separating the remote monitoring device 100 from the stand 20 may be prevented.

Also, since the fixing member may be a thin nail, it is preferred that the fixing ring 421 is formed in a triangle shape where a vertex is put in an upper direction.

Together with that, preferably the fixing ring 421 is provided on a line passing a center of the remote monitoring device 100.

An installation process of the remote monitoring device 100 according to the third embodiment will be described.

To install the remote monitoring device 100, the fixing member (not shown) such as a nail or a screw is installed on a wall the user wants, or an existing fixing member already installed on the place the user wants may be used.

Hence, once the fixing ring 421 of the second mounting part 420 provided in the remote monitoring device 100 is fastened to the fixing member, the installation process has completed.

In case that he/she tries to separate the remote monitoring device 100, all the user have to do is to lift the remote monitoring device 100 a little and move it to unfasten the fixing member from the fixing ring 421. Thereby, the remote monitoring device 100 is completely separated.

By the way, in case that the remote monitoring device 100 is installed by using the stand 20, it is the same as described in the first embodiment.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A remote monitoring device for a laundry machine comprising:
a case for defining an exterior thereof;
a communication modem board provided within the case for transmitting/receiving data with a laundry machine performing washing and drying to control the laundry machine;
a display window for displaying a condition of the laundry machine operation;
a first mounting part provided on a rear surface of the case; and
a stand installed in a remote place from the laundry machine for fastening the first mounting part thereto.

2. The remote monitoring device for a laundry machine of claim 1, further comprising a second mounting part provided in a rear surface of the case to be fastened to a fixing member provided on the wall.

3. The remote monitoring device for a laundry machine of claim 1, wherein a guide rib is formed in the first mounting part and a guide recess corresponding to the guide rib is formed in the stand to sliding-move the remote monitoring device so that the remote monitoring device is mounted in the stand.

4. The remote monitoring device for a laundry machine of claim 1, wherein a guide rib is formed in the guide rib and a guide recess corresponding to the guide rib is formed in the first mounting part to sliding-move the remote monitoring device so that the remote monitoring device is mounted in the stand.

5. The remote monitoring device for a laundry machine of claim 1, wherein the second mounting part is spaced apart a predetermined distance from an upper portion of the first mounting part.

6. The remote monitoring device for a laundry machine of claim 1, wherein the second mounting part is projected from a rear surface of the case and has a fastening groove to insertedly fix the fixing member therein.

7. The remote monitoring device for a laundry machine of claim 6, wherein an opened part connected with the fastening groove is provided in the second mounting part in a direction of the fastening groove so that the fixing member is inserted therein.

8. The remote monitoring device for a laundry machine of claim 1, wherein a concave part, which is some part of the fastening groove concaved upwardly, is provided in the fastening groove to seat the fixing member thereon.

9. The remote monitoring device for a laundry machine of claim 2, wherein the second mounting part comprises,
a fixing ring engaged to the fixing member, and
a support part rotatably supporting the fixing ring to the rear surface of the case.
